(19) United States
(12) Patent Application Publication
(10) Pub. No.: US 2012/0256118 A1
(43) Pub. Date: Oct. 11, 2012

(54) MAGNETIC MATERIAL FOR HIGH-FREQUENCY USE, HIGH-FREQUENCY DEVICE AND MAGNETIC PARTICLES

(75) Inventor: Akira Nakamura, Ebina-shi (JP)

(73) Assignee: MITSUMI ELECTRIC CO., LTD., Tokyo (JP)

(21) Appl. No.: 13/517,013

(22) PCT Filed: Dec. 16, 2010
(86) PCT No.: PCT/JP2010/072617

§ 371 Date: Jun. 18, 2012

(30) Foreign Application Priority Data
Dec. 21, 2009 (JP) 2009-288668

(51) Int. Cl. H01F 1/01

(52) U.S. Cl. 252/62.53; 428/546

(57) ABSTRACT

Disclosed is a magnetic material for high-frequency use in which lower loss is achieved. The magnetic material for high-frequency use is formed from a composite material of magnetic particles and resin, the magnetic particles consist of a simple metal, an alloy, or an inter-metallic compound and have a positive magnetostriction constant, and the shapes of the particles are flattened by means of mechanical processing.

### TECHNICAL FIELD

The present invention relates to a magnetic material for high-frequency use, a high-frequency device, and a magnetic particle.

### BACKGROUND ART

Magnetic materials have conventionally been used for various magnetic appliances. A category of the magnetic materials causing a large change in magnetism under a weak magnetic field is known as soft magnetic material.

The soft magnetic material is classified, based on the material types, into metal-based, amorphous, and oxide-based ones. Of the soft magnetic material, the oxide-based material (ferrite material) has been used in the megahertz range or higher frequency range, since it has a large resistivity and can therefore suppress eddy current loss. One known example of ferrite material adoptable to high-frequency use is a Ni—Zn ferrite material.

The soft magnetic material containing such ferrite material, used in a high-frequency range of 1 GHz or around, causes attenuation of the real part Re(μ) of complex permeability and increase in the imaginary part Im(μ) of complex permeability, associated with magnetic resonance. Of these, the imaginary part Im(μ) of complex permeability causes energy loss P given by P=½·ωμ₀Im(μ)H², so that a large value of the imaginary part Im(μ) of complex permeability is practically undesirable, if it is intended for use as a magnetic core or antenna. In the equation, ω denotes angular frequency, μ₀ denotes permeability of vacuum, and H denotes intensity of magnetic field.

On the other hand, the real part Re(μ) of complex permeability is a value representing magnitude of an effect of condensing electromagnetic wave or a wavelength shortening effect exerted on the electromagnetic wave, so that the value is preferably large from the practical viewpoint.

Alternatively, tangent delta (tan δ=Im(μ)/Re(μ)) is used in some cases as an index for representing the energy loss (magnetic loss) of magnetic material. A large value of tangent delta means that magnetic energy is converted to heat energy in a magnetic material, to thereby degrade transmission efficiency of a necessary level of energy. It is, therefore, preferable that the tangent delta has a small value. In the paragraphs below, the magnetic loss will be explained in terms of tangent delta (tan δ).

Some soft magnetic materials show small values of tan δ in the high-frequency band (GHz band) in the form of thin film. Known thin film materials include Fe-based, high-resistivity soft magnetic film and Co-based, high-resistivity film. The thin film materials are, however, limited in the applicable ranges due to their small volume. In addition, film manufacturing processes are complicated, and need expensive facilities. It may, therefore, be said that there has been no practical magnetic material adoptable to the GHz band.

In some cases aimed at solving the problem, a composite resin magnetic material having a magnetic material dispersed therein is molded by resin molding process. For example, one known technique is to provide an electromagnetic absorber excellent in electromagnetic wave absorption characteristics over wide frequency band, which is obtainable by compounding a nano-crystalline soft magnetic material in a powder form with a resin (see Patent Document 1, for example).

### PRIOR ART DOCUMENTS

### Patent Document

Patent Document 1: Japanese Laid-Open Patent Publication No. H11-354973

### SUMMARY OF THE INVENTION

### Problems to be Solved by the Invention

As described in Patent Document 1, a property required for the composite magnetic material (magnetic material for high-frequency use), intended for use as an electromagnetic wave absorber, is a large value of tan δ. Accordingly, the composite magnetic material has not been able to reduce tan δ (reduce the loss) against a need for a good performance as the electromagnetic wave absorber, and has not been satisfactory from the practical viewpoint of using it as antenna or the like.

It is therefore a subject of the present invention to realize the low-loss of the magnetic material for high-frequency use.

### Means for Solving the Problem

To solve the above problems, one embodiment of the present invention provides a magnetic material for high-frequency use, composed of a composite material of magnetic particles and a resin. The magnetic particles are composed of a simple metal, an alloy or an intermetallic compound. The magnetic particles have a positive magnetostriction constant, and have particle shapes flattened by a mechanical treatment.

Preferably, the magnetic particles have a high permeability plane in the xy-plane orthogonal to the thickness-wise direction.

Preferably, the magnetic particles are dispersed in a resin or rubber material, while aligning their high permeability planes orthogonal to the thickness-wise direction.

Preferably, the magnetic particles are aligned in the material by injection molding or compression molding.

Preferably, one embodiment of the present invention provides a high-frequency device comprising at least one of antenna, circuit board and inductor.

According to the present invention, a magnetic particle is composed of a simple metal, an alloy or an intermetallic compound. The magnetic particle has a positive magnetostriction constant, and have a particle shape flattened by a mechanical treatment.

Preferably, the magnetic particle has a high permeability plane in the xy-plane orthogonal to the thickness-wise direction.

### Advantageous Effect of Invention

According to the present invention, the magnetic material for high-frequency use may successfully realize the low-loss.

### BRIEF DESCRIPTION OF DRAWINGS

FIG. 1 This is a drawing illustrating diameter (d) and thickness (t) of a magnetic particle.

FIG. 2 This is a drawing illustrating a relation between magnetic resonance frequency and residual stress.

FIG. 3 This is a drawing illustrating a cross-sectional SEM image of a magnetic material for high-frequency use.

FIG. 4A This is a drawing illustrating frequency characteristics of permeability Re(μ) and tan δ of Comparative Example, and frequency characteristics of permeability Re(μ) and tan δ of Example of the present invention.

FIG. 4B This is a characteristic table summarizing permeability Re(μ) and tan δ, at 200 MHz and 700 MHz, of Example and Comparative Example.

FIG. 5A This is a drawing illustrating an exemplary antenna using a magnetic material for high-frequency use.

FIG. 5B This is a drawing illustrating another exemplary antenna using the magnetic material for high-frequency use.

FIG. 5C This is a drawing illustrating another exemplary antenna using the magnetic material for high-frequency use.

FIG. 5D This is a drawing illustrating another exemplary antenna using the magnetic material for high-frequency use.

FIG. 6 This is a drawing illustrating still another exemplary antenna using the magnetic material for high-frequency use.

FIG. 7 This is a drawing illustrating an exemplary inductor using the magnetic material for high-frequency use.

FIG. 8 This is a drawing illustrating an exemplary circuit board using the magnetic material for high-frequency use.

### DESCRIPTION OF THE PREFERRED EMBODIMENTS

Embodiments of the present invention will be detailed below, referring to the attached drawings. Note that the scope of the invention is not restricted by the examples illustrated in the drawings.

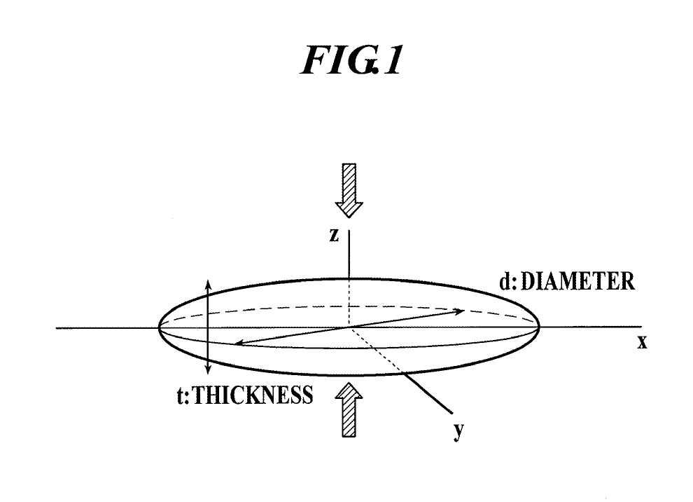

FIG. 1 is a schematic drawing illustrating a magnetic particle, wherein d denotes diameter of the magnetic particle, and t denotes thickness of the magnetic particle. x, y and z denote direction of crystal axes, where the z-direction (thickness-wise direction) corresponds to the direction of compression axis (direction in which compressive force effects in a process of flattening the magnetic particle). The process of flattening the magnetic particle (referred to as flattening process, hereinafter) is a mechanical process typically using rolling mill, bead mill, ball mill, attritor or the like.

Magnetoelastic energy E_{σ} ascribable to residual stress in the magnetic particle illustrated in FIG. 1 is given by the equation (1) below:

$$[ Mathematical Formula 1 ]$$

$${E}_{σ} = - \frac{3}{2} λσ ( {cos}^{2} θ - \frac{1}{3} ) \qquad ( 1 )$$

where, λ is magnetostriction constant, σ is residual stress, and θ is angle between the compression axis and direction of magnetism.

Using uniaxial magnetic anisotropy constant K_{uσ}, the equation (1) is also given as the equation (2) below:

$$[ Mathematical Formula 2 ]$$

$${E}_{σ} = - \frac{3}{2} λσ ( {cos}^{2} θ - \frac{1}{3} ) = - {K}_{u σ} \cdot {cos}^{2} θ \qquad ( 2 )$$

If the magnetostriction constant is positive (λ>0), and the residual stress is compressive (σ<0), then K_{uσ} is negative, indicating shift of magnetic resonance frequency fr, according to a mechanism similar to that for some of hexagonal ferrites. Given that Hₐ₁ is anisotropic magnetic field in the plane of flattening (the xy-plane orthogonal to the thickness-wise, z-axis), and Hₐ₂ is anisotropic magnetic field in the direction of compression axis, the magnetic resonance frequency fr is given by the equation (3) below:

$$[ Mathematical Formula 3 ]$$

$$fr = \frac{V}{2 π} \cdot \sqrt{{H}_{{a}_{1}} \cdot ( {H}_{{a}_{1}} + {H}_{{a}_{2}} )} \qquad ( 3 )$$

where, ν denotes gyromagnetic constant.

By further using Hₐ₁=2|K₁|/Iₛ, and Hₐ₂=2|K_{uσ}|/Iₛ, the magnetic resonance frequency is given by the formula (4) below:

$$[ Mathematical Formula 4 ]$$

$$fr = \frac{v}{2 π} \cdot \sqrt{\frac{2 \vert {K}_{i} \vert}{{I}_{s}} \cdot ( \frac{2 \vert {K}_{1} \vert}{{I}_{s}} + \frac{2 \vert {K}_{s σ} \vert}{{I}_{s}} )} = \frac{v}{π} \frac{\sqrt{\vert {K}_{1} \vert \cdot ( \vert {K}_{1} \vert + \vert {K}_{s σ} \vert )}}{{I}_{s}} = \frac{v}{π} \frac{\sqrt{\vert {K}_{1} \vert \cdot ( \vert {K}_{1} \vert + \frac{3}{2} \vert λσ \vert )}}{{I}_{s}} \qquad ( 4 )$$

where, K₁ denotes magnetic anisotropy constant, and Iₛ denotes saturation magnetization.

Now, using the equation (4), the magnetic resonance frequency fr will be calculated making reference to a flattened particle having a composition of Co-50 at % Fe particle. Co—Fe of this composition has positive values both for magnetostriction constants λ₁₀₀ and λ₁₁₁ which are principal directions, expresses the effects of the present invention in a large number of particles, and is preferable by virtue of its large saturation magnetization and high frequency limit (the Snoek's limit). While this embodiment will be explained below referring to an exemplary case where the magnetic particle is composed of Co—Fe (alloy), it may alternatively be composed of a simple metal or an intermetallic compound.

The magnetic resonance frequency fr is calculated by putting, as the individual values relevant to Co-50 at % Fe: Is=2.35 (Wb/m²), K₁=−11×10³ (J/m³), λ=150×10⁻⁶, and γ=1.105×10⁵ g (m/A·s)=2.210×10⁵ (m/A·s), into the equation (4).

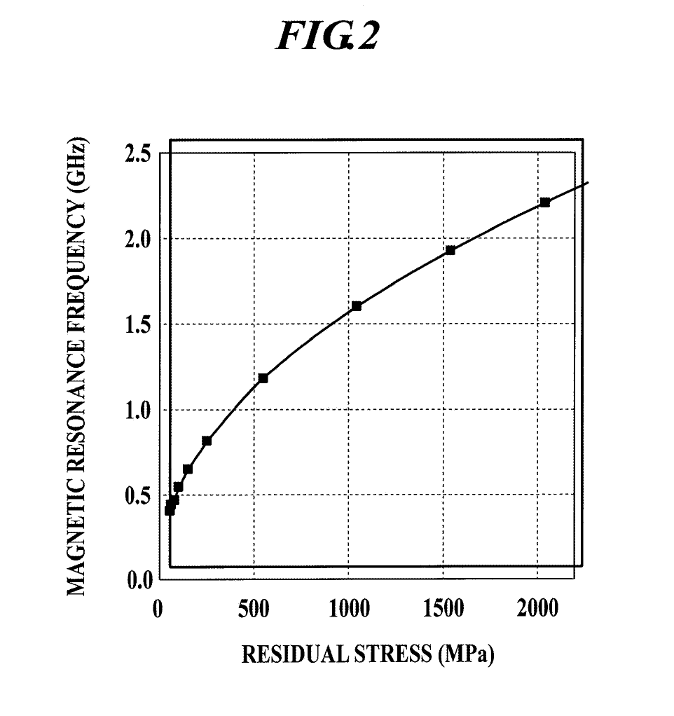

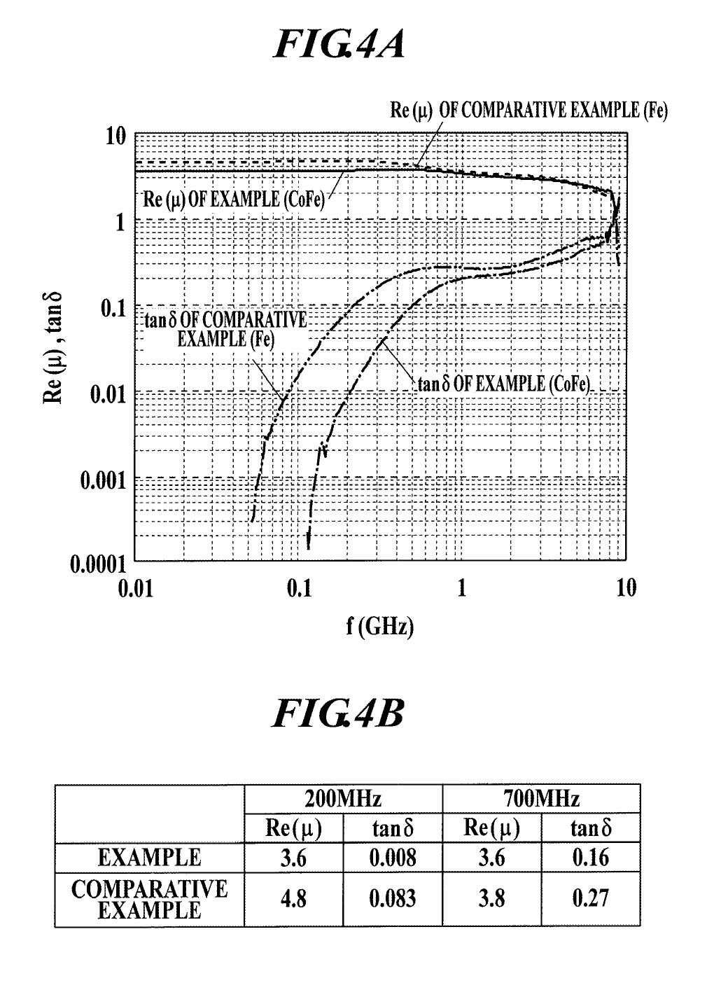

FIG. 2 illustrates a relation between fr, obtained by putting the individual values into the equation (4), and residual stress σ. The ordinate represents magnetic resonance frequency fr, and the abscissa represents residual stress σ. As is known from FIG. 2, the magnetic resonance frequency fr elevates as the residual stress σ increases. When the magnetic resonance frequency fr elevates, the frequency characteristics of tan δ shifts towards the high-frequency side (see FIGS. 4A and 4B), and tan δ then decreases in a frequency band not higher than the magnetic resonance frequency.

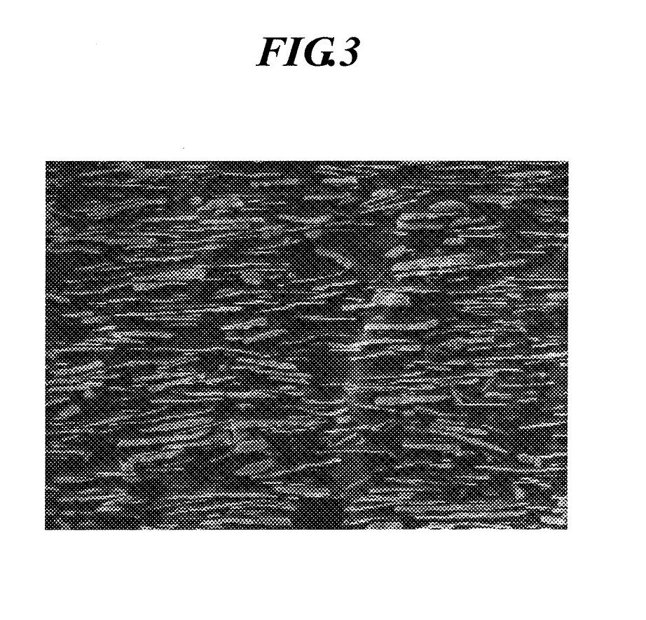

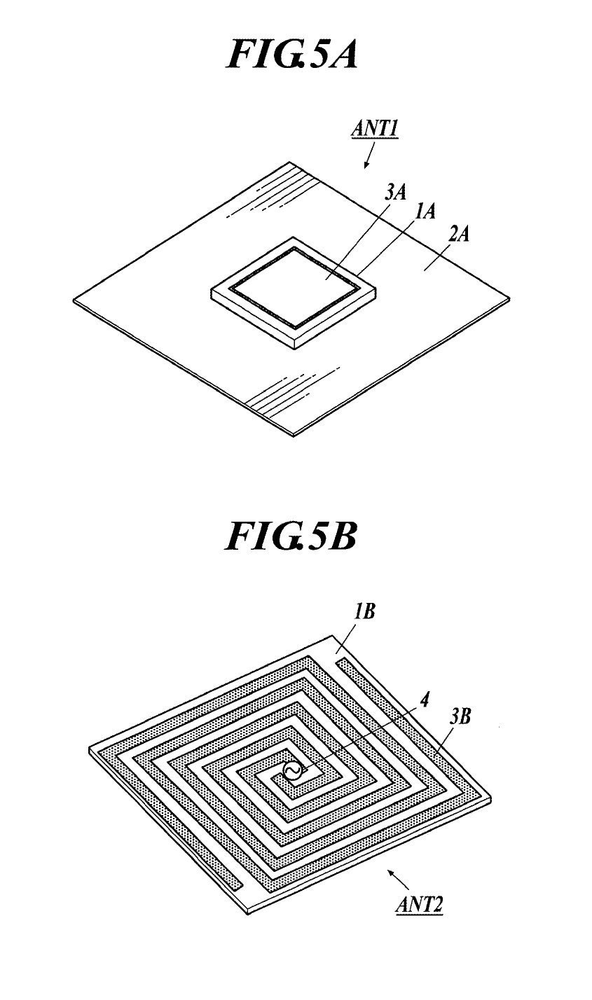

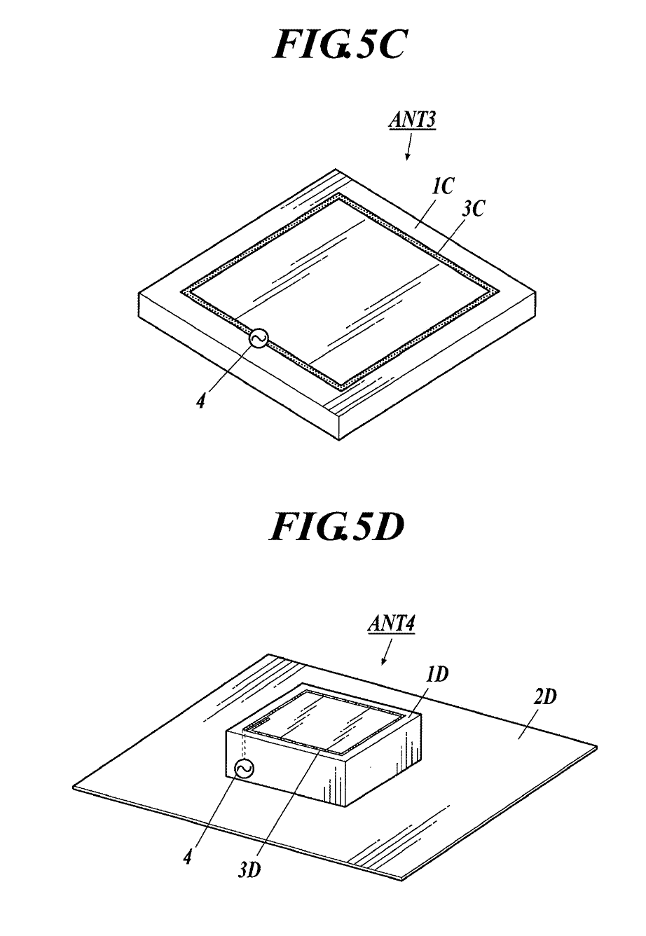

FIG. 3 illustrates a cross-sectional SEM image of a magnetic material for high-frequency use, obtained by kneading the magnetic substance for high-frequency use into a rubber material, followed by compression molding. Specific conditions of molding include magnetic material: Co-50 wt % Fe, average particle size: 5.8 μm, method of flattening: bead milling, rubber material: CPE (chlorinated polyethylene rubber), method of molding: heat pressing (compression molding), mold size: 80 (mm)×80 (mm)×1 (mmt), and filling ratio of magnetic particle: 20 vol %. The SEM image illustrated in FIG. 5 was captured under a field emission scanning electron microscope (FESEM), under a acceleration voltage of 10 kV, at a 2000× magnification.

Since compression molding is adopted as the molding method, planes of flattening of the individual magnetic particles (in-plane direction of the xy-plane, or in-plane direction orthogonal to the z-axis which corresponds to the thickness-wise direction), which correspond to the high permeability plane, are arranged (or aligned) in parallel with each other, by means of compression in the molding process.

The molding method may alternatively be injection molding. In the injection molding, when a molten magnetic substance (a thermoplastic resin and a magnetic material) for high-frequency use, melted under heating, is injected into a molding die, the high permeability planes of the magnetic particles are aligned in the direction of small resistance (in other words, in the in-plane direction of the xy-plane). The molding method is not limited thereto, wherein another possible method is such as dispersing the magnetic particles in a solvent, and coating the dispersion on a base by casting, spin coating, dip coating or the like, and then solidifying the coated dispersion.

Alternatively, the high-permeability planes may be aligned in a magnetic field, rather than by mechanical molding (compression molding or injection molding).

Relations of the permeability Re(μ) or tan δ to frequency are shown in FIG. 4A. More specifically, FIG. 4A is a drawing illustrating frequency characteristics of permeability Re(μ) and tan δ of Comparative Example (Fe), and frequency characteristics of permeability Re(μ) and tan δ of Example of the present invention (containing the magnetic material for high-frequency use, having a positive magnetostriction constant, and having particle shapes flattened by a mechanical treatment, that is, magnetic material CoFe for high-frequency use explained referring to FIG. 3). The ordinate represents permeability Re(μ) or tan δ, and the abscissa represents frequency. Note that “relative permeability” generally used corresponds herein to the real part Re(μ) of complex relative permeability. In this embodiment, this will be simply referred to as permeability Re(μ).

As seen in FIG. 4A, the present invention characteristically showed small tan δ over a wide wavelength range from 100 MHz to 7 GHz. While tan δ at 100 MHz or below was not acquired due to measurement limit, it is obvious in principle that the present invention makes effects also in this range. The magnetic material for high-frequency use is therefore applicable to antenna.

FIG. 4B is a characteristic table summarizing permeability Re(μ) and tan δ, at 200 MHz and 700 MHz, of Example of the present invention and Comparative Example. As seen in FIG. 4B, tan δ values in Example were found to be smaller at both of 200 MHz and 700 MHz, than those in Comparative Example. The permeability Re(μ) value (3.6) in Example was found to be kept unchanged over the range from 200 MHz to 700 MHz.

Next, examples of the high-frequency device (antenna, inductor, circuit board) formed by using the magnetic material for high-frequency use according to the present invention will be explained referring to FIG. 5A to FIG. 8.

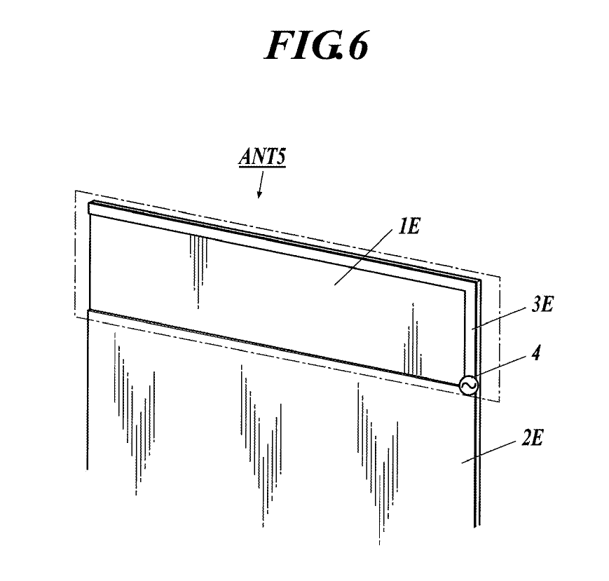

FIG. 5A to FIG. 5D and FIG. 6 are drawings illustrating examples of antenna formed by using (applying) the magnetic material for high-frequency use. An antenna ANT1 illustrated in FIG. 5A is configured to have a magnetic material for high-frequency use 1A, a grounding plate 2A, and an electrode 3A. In the configuration of ANT1, the magnetic material for high-frequency use 1A is formed on the grounding plate 2A, and the electrode 3A is formed on the magnetic material for high-frequency use LA.

An antenna ANT2 illustrated in FIG. 53 is configured to have a magnetic material for high-frequency use 1B, an electrode 3B, and an AC power source 4. The AC power source 4 herein symbolically represents a point of supply of AC power (the same will also apply to the AC power sources illustrated in FIG. 5C, FIG. 5D and FIG. 6). In the configuration of ANT2, the electrode 3B is formed on the magnetic material for high-frequency use 1B. The electrode 3B herein may alternatively be built in the magnetic material for high-frequency use 1B.

An antenna ANT3 illustrated in FIG. 5C is configured to have a magnetic material for high-frequency use 1C, an electrode 3C, and the AC power source 4. In the configuration of ANT3, the electrode 3C may alternatively be arranged inside the magnetic material for high-frequency use 1C.

An antenna ANT4 illustrated in FIG. 5D is configured to have a magnetic material for high-frequency use 1D, a grounding plate 2D, an electrode 3D, and the AC power source 4. In the configuration of ANT4, the magnetic material for high-frequency use 1D is formed on the grounding plate 2D, and the electrode 3D is built in the magnetic material for high-frequency use 1D. Alternatively, the electrode 3D may be arranged inside the magnetic material for high-frequency use 1C.

An antenna ANT5 illustrated in FIG. 6 is configured to have a magnetic material for high-frequency use 1E, a grounding plate 2E, and an electrode 3E. In the configuration of ANT5, one surface of the magnetic material for high-frequency use 1E is formed at the same height with at least one surface of the grounding plate 2E, and the electrode 3E is formed on the magnetic material for high-frequency use 1E.

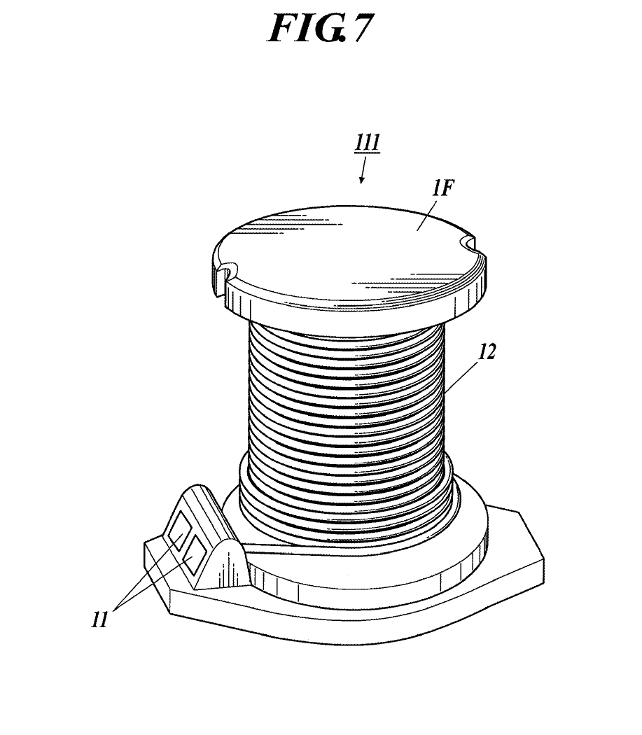

Next, an exemplary inductor 111 using the magnetic material for high-frequency use will be explained, referring to FIG. 7. As seen in FIG. 7, the inductor 111 is configured to have a magnetic material for high-frequency use 1F, terminals 11, and a coil 12. The magnetic material for high-frequency use 1F is applied to the inductor 111 according to this configuration.

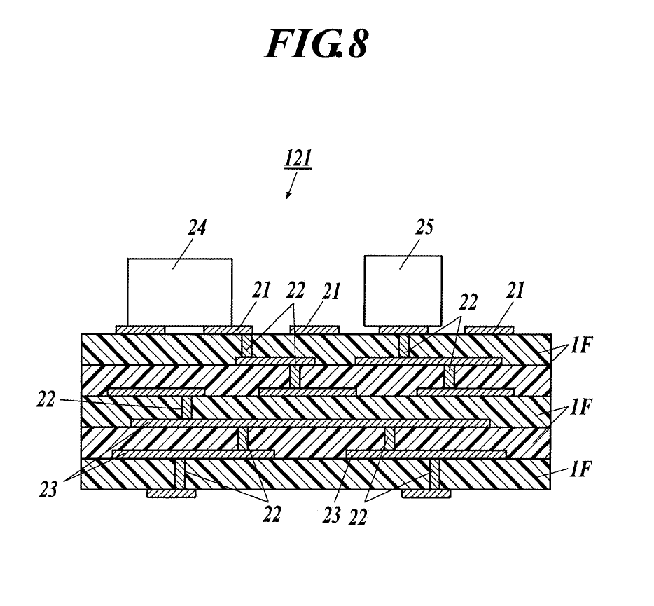

Next, an exemplary circuit board 121 using the magnetic material for high-frequency use will be explained, referring to FIG. 8. As seen in FIG. 8, the circuit board is configured to have the magnetic materials for high-frequency use 1F, lands 21, viaholes 22, internal electrodes 23, and mounted components 24, 25. While the circuit board illustrated in FIG. 8 uses the high-frequency magnetic material 1F for all layers, the high-frequency magnetic material 1F may be used at least one of these layers. The magnetic material for high-frequency use 1F is applied to the circuit board 121 according to this configuration.

As described in the embodiments in the above, the magnetic material for high-frequency use containing magnetic particles (Co—Fe, for example), having positive magnetostriction constant and having flattened particle shapes, shows the frequency characteristics of tan δ shifted towards the high-frequency side. Accordingly, the frequency range in which tan δ may be kept small is expanded, and thereby tan δ may be lowered also in the low frequency region. More specifically, tan δ may be lowered as compared with Comparative Example, over a wide frequency range from 100 MHz to 7 GHz, and even in the frequency band of and 100 MHz or below. Low-loss by the magnetic material for high-frequency use may thus be realized.

Since magnetostatic interactions among the magnetic particles are less affective to the magnetic characteristics, the magnetic material for high frequency use is less likely to degrade the frequency characteristics of permeability and is less likely to increase tan δ, even if the filling ratio of the magnetic particles is elevated. Accordingly, the degree of freedom of selecting an appropriate filling ratio, depending on the product design (magnetic appliances), may be increased.

Since the magnetic material for high-frequency use is manufactured by compression molding or injection molding of the magnetic substance for high-frequency use, so that the high permeability direction may readily be aligned in plane (in the xy-plane).

The magnetic material for high-frequency use may be applied to at least one of antenna, circuit board and inductor. By applying the magnetic material for high-frequency use having small tan δ to an antenna for example, radiation efficiency of antenna may be improved.

The description in the above-described embodiment dealt with examples of the magnetic material for high-frequency use, the magnetic substance for high-frequency use, and the high-frequency device of the present invention, without limiting thereto the present invention.

For example, the magnetic particle may be coated on the surface thereof with a non-magnetic material (phosphate salt, silica, etc.) for the purpose of electric isolation among the particles, and the magnetic material for high-frequency use may be formed using the thus-coated magnetic particles.

The magnetic material for high-frequency use, exemplified in the above-described embodiments as a composite material of a magnetic material and a resin, is not limited thereto. For example, a composite material of a magnetic material and an inorganic substance (inorganic dielectric, glass filler, electro-conductive material) may be used as the magnetic material for high-frequency use.

The resin used herein may be selected from various thermosetting resins or various thermoplastic resins.

Examples of an apparatus for mixing the resin material (resin material showing fluidity) and the magnetic particles adoptable herein include extrusion molding machine, planetary mixer, and ball mill.

The molding method may alternatively be extrusion molding.

### INDUSTRIAL APPLICABILITY

The present invention is useful for magnetic particles, a high-frequency magnetic material composed of a composite material of the magnetic particles and a resin, and a high-frequency device using the high-frequency magnetic material.

### EXPLANATION OF THE REFERENCE SIGNS

1A, 1B, 1C, 1D, 1E, 1F magnetic material for high-frequency use
2A, 2D, 2E grounding plate
3A, 3B, 3C, 3D, 3E electrode

1. A magnetic material for high-frequency use comprises a composite material of magnetic particles and a resin,
wherein the magnetic particles are composed of a simple metal, an alloy or an intermetallic compound, having a positive magnetostriction constant, and having particle shapes flattened by a mechanical treatment.

2. The magnetic material for high-frequency use of claim 1,
wherein the magnetic particles have a high permeability plane in the xy-plane orthogonal to a thickness-wise direction.

3. The magnetic material for high-frequency use of claim 1,
wherein the magnetic particles are dispersed in a resin or rubber material, while aligning their high permeability planes orthogonal to a thickness-wise direction.

4. The magnetic material for high-frequency use claim 3,
wherein the magnetic particles are aligned in the material by injection molding or compression molding.

5. A high-frequency device comprising at least one of an antenna, a circuit board and an inductor formed by using the magnetic material for high-frequency use described in claim 1.

6. A magnetic particle composed of a simple metal, an alloy or an intermetallic compound, having a positive magnetostriction constant, and having a particle shape flattened by a mechanical treatment.

7. The magnetic particle of claim 6, having high permeability plane in the xy-plane orthogonal to the thickness-wise direction.

8. The magnetic material for high-frequency use of claim 2,
wherein the magnetic particles are dispersed in a resin or rubber material, while aligning their high permeability planes orthogonal to the thickness-wise direction.

9. The magnetic material for high-frequency use of claim 8,
wherein the magnetic particles are aligned in the material by injection molding or compression molding.

10. A high-frequency device comprising at least one of an antenna, a circuit board and an inductor formed by using the magnetic material for high-frequency use described in claim 2.

11. A high-frequency device comprising at least one of an antenna, a circuit board and an inductor formed by using the magnetic material for high-frequency use described in claim 4.

12. A high-frequency device comprising at least one of an antenna, a circuit board and an inductor formed by using the magnetic material for high-frequency use described in claim 4.

13. A high-frequency device comprising at least one of an antenna, a circuit board and an inductor formed by using the magnetic material for high-frequency use described in claim 8.

14. A high-frequency device comprising at least one of an antenna, a circuit board and an inductor formed by using the magnetic material for high-frequency use described in claim 9.
